(19) United States
(12) Patent Application Publication
(10) Pub. No.: US 2023/0318069 A1
(43) Pub. Date: Oct. 5, 2023

(54) ALL SOLID-STATE BATTERY UNIT

(71) Applicant: HONDA MOTOR CO., LTD., Tokyo (JP)

(72) Inventors: Takuya Taniuchi, Wako-shi (JP); Toshiyuki Ariga, Wako-shi (JP)

(21) Appl. No.: 18/109,882

(22) Filed: Feb. 15, 2023

(30) Foreign Application Priority Data
Mar. 30, 2022 (JP) 2022-057006

(51) Int. Cl. H01M 10/617; H01M 10/0525; H01M 10/613; H01M 10/615; H01M 10/48

(52) U.S. Cl. CPC H01M 10/617; H01M 10/0525; H01M 10/613; H01M 10/615; H01M 10/482; H01M 10/486

(57) ABSTRACT

An all solid-state battery unit includes: an all solid-state battery module in which a plurality of all solid-state battery cells are laminated and; an alternating temperature unit configured to heat or cool the all solid-state battery module; a control unit configured to control the alternating temperature unit, wherein the control unit controls the alternating temperature unit depending on either or both of values of a State of Charge of the all solid-state battery module and a temperature of the all solid-state battery module.

### CROSS-REFERENCE TO RELATED APPLICATION

Priority is claimed on Japanese Patent Application No. 2022-057006, filed Mar. 30, 2022, the content of which is incorporated herein by reference.

### BACKGROUND OF THE INVENTION

### Field of the Invention

The present application relates to an all solid-state battery unit having an all solid-state battery module where the plurality of all solid-state battery cells are laminated.

### Description of Related Art

A capacitor which supplies power to a motor, and the like is mounted in a vehicle such as EV (Electric Vehicle), HEV (Hybrid Electrical Vehicle), and the like. It is common the capacitor is provided with the plurality of secondary batteries.

As the secondary battery mounted in the EV or the HEV, a lithium ion battery (LIB) is used conventionally and widely, however, there is a fear of the overheating, ignition and the like of the lithium ion battery due to property of electrolyte. For this reason, the all solid-state battery having properties such as higher safeness, wider useable temperature range, shorter charge time, and the like compared to the conventional lithium ion battery is drawing attention.

As a manufacturing method of the all solid-state battery, for example, it is common the all solid-state battery is where a positive electrode laminated body including a positive electrode solid-state electrolyte and a positive electrode mixture and a negative electrode laminated body including a negative electrode solid-state electrolyte and a negative electrode mixture are integrated by pressure bonding. Such all solid-state battery has lower fear of overheating, ignition and the like and higher safeness by using solid-state electrolyte.

However, in order to maintain appropriate output property and filling property, it is important in the all solid-state battery to maintain a state where the positive electrode laminated body and the negative electrode laminated body are bonded by a surface pressure in an appropriate range. For example, a battery module configured to apply a restraint load by using an elastic body with respect to a laminated body where the plurality of unit cells are laminated is disclosed in Japanese published unexamined application 2019-128979 (hereinafter, Patent literature 1). A battery module configured to adjust a restraint load by using a pressure adjusting member with respect to a laminated body where the plurality of unit cells are laminated is disclosed in Japanese published unexamined application 2019-128980 (hereinafter, Patent literature 2).

### SUMMARY OF THE INVENTION

However, battery modules disclosed in Patent literature 1 and Patent literature 2 are to maintain restraint force in response to expansion and contraction of a laminated body of a unit cell. On the contrary, since charge and discharge properties of the all solid-state battery are likely to be changed by temperature and State of Charge (SOC) and the like, the all solid-state battery is required to improve energy efficiency by stabilizing the charge and discharge properties in response to fluctuations of such State of Charge and temperature.

Aspects according to the present invention have been made in view of the problems described above, and an object thereof is to provide an all solid-state battery unit that can improve energy efficiency by stabilizing the charge and discharge properties in response to fluctuations of State of Charge and temperature of all solid-state battery module.

In order to solve the problems described above and achieve the object, the present invention has adopted the following aspects.

(1) An all solid-state battery unit of one aspect according to the present application includes: an all solid-state battery module in which a plurality of all solid-state battery cells are laminated; an alternating temperature unit configured to heat or cool the all solid-state battery module; and a control unit configured to control the alternating temperature unit, wherein the control unit controls the alternating temperature unit depending on either or both of values of a State of Charge of the all solid-state battery module and a temperature of the all solid-state battery module.

According to the above aspect (1), the all solid-state battery unit of which charge and discharge properties are always stabilized can be realized by heating the all solid-state battery module by the alternating temperature device even if the State of Charge of the all solid-state battery module is lowered.

(2) In the above aspect (1), the control unit performs a control to increase the temperature of the all solid-state battery module by the alternating temperature unit in response to a decrease of the State of Charge of the all solid-state battery module.

(3) In the above aspect (1) or (2), a surface pressure increasing member composed of a thermal expandable materials may be formed to come in contact with the all solid-state battery cell in the all solid-state battery module.

(4) In any one of the above aspects (1) to (3), the control unit may have a temperature sensor configured to detect the temperature of the all solid-state battery module.

(5) In any one of the above aspects (1) to (4), the control unit may further control the alternating temperature unit depending on a value of a load applied to the all solid-state battery cell.

(6) In any one of the above aspects (1) to (5), the alternating temperature unit may be a heater.

According to the aspects of the present invention, it is possible to provide an all solid-state battery unit that can improve energy efficiency by stabilizing the charge and discharge properties in response to fluctuations of temperature and State of Charge of all solid-state battery module.

### BRIEF DESCRIPTION OF THE DRAWINGS

FIG. 1 is a model cross-section view illustrating an all solid-state battery unit of one embodiment of the present invention.

FIG. 2 is a graph illustrating a relationship between the thickness and a State of Charge (SOC) of an all solid-state battery cell.

FIG. 3 is a graph illustrating a relationship between an internal resistance and a surface pressure (a load applied to an all solid-state battery cell) of the all solid-state battery cell.

FIG. 4 is a graph illustrating a relationship between an internal resistance and a temperature of an all solid-state battery cell.

### DETAILED DESCRIPTION OF THE INVENTION

Hereinafter, an all solid-state battery unit of one embodiment of the present invention will be described with reference to the drawings. The embodiment shown below is a specific description to give a better understanding of the intent of the invention and is not intended to limit the invention unless otherwise specified. In the drawings used in the following description, key parts may be enlarged for the sake of convenience in order to make the features of the invention easier to understand, and the dimensional proportions of each component may not be the same as in reality.

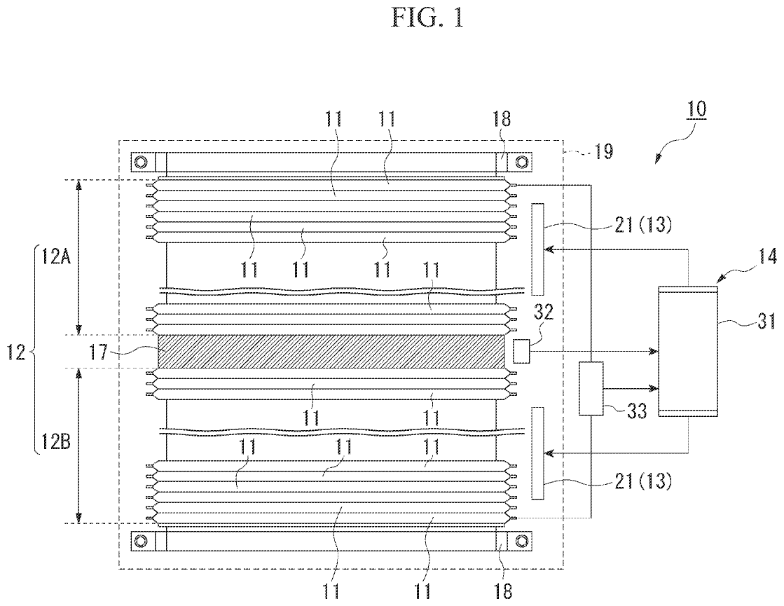

A configuration example of an all solid-state battery unit of one embodiment of the present application will be explained. FIG. 1 is a model cross-section view illustrating an all solid-state battery unit of one embodiment of the present invention. The all solid-state battery unit 10 of the present embodiment has an all solid-state battery module 12 in which a plurality of all solid-state battery cells 11, 11 . . . are laminated, an altering temperature device 13, a control unit 14, and a surface pressure increasing member 17.

The all solid-state battery cell 11 may have a configuration similar to a well-known all solid-state battery cell, for example, a configuration wherein a positive electrode laminated body in which a positive electrode mixture layer of a positive electrode layer and a positive electrode solid-state electrolyte layer are pressurized and bonded, and a negative electrode laminated body in which a negative electrode mixture layer of a negative electrode layer and a negative electrode solid-state electrolyte layer are pressurized and bonded, are pressurized and bonded.

The all solid-state battery module 12 is where the plurality of the aforementioned all solid-state battery cells 11 are laminated, in the present embodiment, is configured by a first all solid-state battery module 12A which is formed on one end side across the surface pressure increasing member 17 as described below in a center, and a second all solid-state battery module 12B which is formed on the other end side.

Each of the first all solid-state battery module 12A, and the second all solid-state battery module 12B is consisted by a configuration where the same number of the all solid-state battery cells 11, 11 . . . are laminated in a symmetry shape. The all solid-state battery module 12 is sandwiched by a frame member 18 with a predetermined binding force at upper and lower end portions in a laminate direction of the all solid-state battery cells 11, 11. . . . The plurality of the all solid-state battery cells 11, 11 . . . are mutually electrically connected in serial and/or parallel. The all solid-state battery module 12 may be accommodated within, for example, a heat-shielded housing 19.

The alternating temperature device 13 has a heater 21 disposed in proximity to the all solid-state battery module 12. In the present embodiment, heaters 21a, 21b are disposed in proximity to the first all solid-state battery module 12A and the second all solid-state battery module 12B. Such heater 21 can heat the all solid-state battery module 12 to increase the temperature.

When the all solid-state battery module 12 is heated by the heater 21 to increase the temperature, the individual all solid-state battery cell 11, 11 . . . becomes inflated compared to before the increase of the temperature. As a result, a load (surface pressure) applied to the all solid-state battery cell 11 is increased. When the load (surface pressure) applied to the all solid-state battery cell 11 is increased, an internal resistance is decreased. Therefore, when the all solid-state battery module 12 is heated by the heater 21 to increase the temperature, the internal resistance of the individual all solid-state battery cell 11, 11 . . . can be lowered.

The heater 21 configuring the alternating temperature device 13 can be disposed at an arbitrary position of the all solid-state battery module 12, the disposed position is not limited. For example, a sheet-like heater may be formed to be sandwiched between the all solid-state battery cells 11, 11 or may be formed on an upper surface and a lower surface of the all solid-state battery module 12.

The operation power of such heater 21 may be configured to use the output power of the all solid-state battery module 12 or may be configured to supply power from an external portion.

As the alternating temperature device 13, a Peltier element and the like can also be used with the exception of such heater 21 of the present embodiment. When the Peltier element is used as the alternating temperature device 13, the all solid-state battery module 12 can be cooled to lower the temperature.

The control unit 14 has a control circuit portion 31 comprising an interface circuit and the like which controls an operation of the altering temperature device 13, a temperature sensor 32 which detects a temperature of the all solid-state battery module 12 and outputs to the control circuit portion 31, and a SOC sensing circuit 33 which detects a State of Charge (SOC) of the all solid-state battery module 12 and outputs to the control circuit portion 31.

The temperature sensor 32 may be formed, for example, at a position coming in contact with the all solid-state battery module 12. A configuration may be adopted where the temperature sensor 32 are formed at the plurality of positions of all solid-state battery module 12 and a temperature distribution can be detected.

The SOC sensing circuit 33 may be, for example, an output voltmeter. The State of Charge (SOC) can be calculated from a change of an open-circuit voltage (OCV) of the all solid-state battery module 12.

In the control circuit portion 31, the temperature of the all solid-state battery module 12 is changed by controlling the alternating temperature device 13, in the present embodiment, is increased by the heater 21 depending on the State of Charge (SOC) and the temperature of the all solid-state battery module 12 detected by the SOC sensing circuit 33 and the temperature sensor 32.

In the present embodiment, the surface pressure increasing member 17 is provided between the first all solid-state battery module 12A and the second all solid-state battery module 12B which configure all solid-state battery module 12. The surface pressure increasing member 17 is composed of a thermal expandable materials of which the volume is increased depending on the increase of the surrounding temperature. For example, the resin material can use as the thermal expandable materials.

When the temperature of the all solid-state battery module 12 is increased by the heater 21 configuring the alternating temperature device 13, the volume of such surface pressure increasing member 17 is increased due to the thermal expansion. Then, as the volume of the surface pressure increasing member 17 is increased, the load (surface pressure) applied to the all solid-state battery cells 11, 11 . . . laminated to come in contact with this surface pressure increasing member 17 is increased and the internal resistance is lowered.

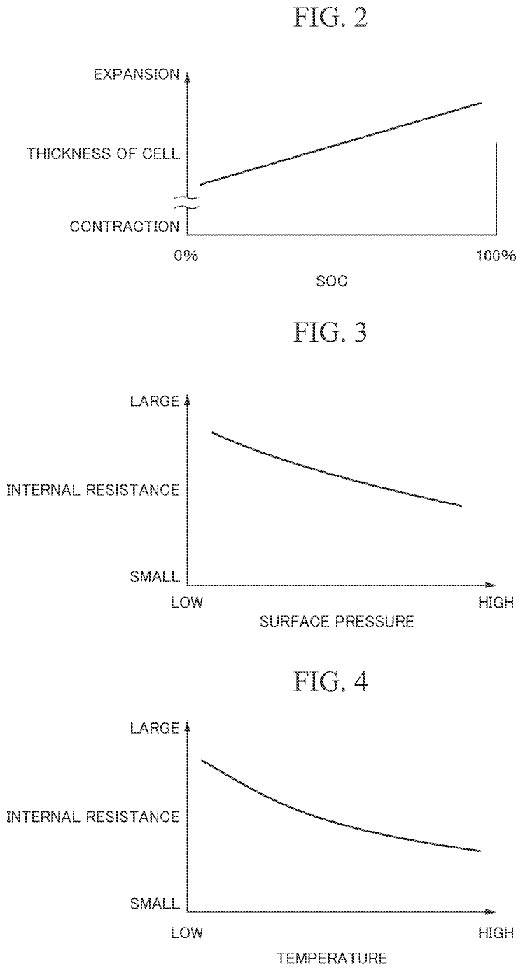

An operation of the all solid-state battery unit 10 of the present embodiment having the above-mentioned configuration will be explained. In the all solid-state battery cell 11, as the State of Charge (SOC) becomes large, the thickness of the individual all solid-state battery cell 11 is increased (for example, see a graph in FIG. 2). That is, when the State of Charge is lowered by power being drawn (being discharged) from a state of the high State of Charge (for example 100%), the thickness of the individual all solid-state battery cell 11 is decreased.

The all solid-state battery module 12 is sandwiched by a frame member 18 with a predetermined binding force at upper and lower end portions in a laminate direction of the all solid-state battery cells 11, 11. . . . Therefore, when the thickness of the individual all solid-state battery cell 11 is decreased, the load (surface pressure) applied to the all solid-state battery cell 11 is lowered. As a result, the internal resistance of the all solid-state battery cell 11 is increased, the discharge efficiency is lowered (for example, see a graph in FIG. 3). The internal resistance of the all solid-state battery cell 11 is increased as the temperature of the all solid-state battery cell 11 is lower (for example, see a graph in FIG. 4).

For this reason, in the present embodiment, the control circuit portion 31 configuring the control device 14 controls the load applied to the all solid-state battery cell 11 such that the internal resistance of the all solid-state battery module 12 becomes minimum.

Specifically, for example, an arbitrary threshold value with respect to the State of Charge (SOC) of the all solid-state battery module 12 is set, and two states of SOC (small: less than SOC50%) and SOC (large: SOC50% or more) are set on the border of this threshold value. An arbitrary threshold value with respect to temperature of all solid-state battery module 12 is also set, and two states of the temperature (low: less than 30° C.) and the temperature (high: 30° C. or more) are set on the border of this threshold value.

Then, when the State of Charge (binary) obtained by SOC detection circuit 33 becomes to the SOC (small), the control device 14 refers to an output value of the temperature sensor 32, then if it is the temperature (low), operates the heater 21 which is the alternating temperature device 13 to heat the all solid-state battery cells 11, 11 . . . to increase the temperature until it becomes to the state of the temperature (high).

The internal resistance of the all solid-state battery cell 11 is lowered by heating by such heater 21. As a result, even if the State of Charge (SOC) of all solid-state battery module 12 is lowered by the discharge, and then the load (surface pressure) applied to the all solid-state battery cell 11 is lowered, the charge and discharge properties can be always stabilized by suppressing the increase of the internal resistance of the all solid-state battery cell 11.

As above, according to the all solid-state battery unit 10 of one embodiment of the present application, the all solid-state battery unit 10 of which charge and discharge properties are always stabilized can be realized by heating the all solid-state battery module 12 by the heater 21 even if the State of Charge (SOC) of the all solid-state battery module 12 is lowered.

In the above-mentioned embodiment, a load applying to the all solid-state battery cell 11 is controlled by detecting both of the State of Charge (SOC) and the temperature of the all solid-state battery module 12. However, a configuration may be adopted where a temperature of the all solid-state battery cell 11 is controlled by detecting either one of the temperature and the State of Charge (SOC) of all solid-state battery module 12, and the internal resistance is always minimized.

In the above-mentioned embodiment, for simplifying the configuration of the control circuit portion 31, both of the State of Charge (SOC) and the temperature of all solid-state battery module 12 are controlled by binary on the border of one set threshold value. However, it may be controlled by multiple values where the plurality of threshold values are set or controlled by continuous value.

In the above-mentioned embodiment, for simplifying the configuration of the control circuit portion 31, both of the State of Charge (SOC) and the temperature of all solid-state battery module 12 are controlled by binary on the border of one set threshold value. However, it may be controlled by multiple values where the plurality of threshold values are set or controlled by continuous value.

A configure as another embodiment may be adopted where, as the control value of the alternating temperature device 13 by the control device 14, either or both of values of the State of Charge of the all solid-state battery module and the temperature of the all solid-state battery module as described above are referred, and a value of the load (cell load) applied to the plurality of the all solid-state battery cell 11, 11 . . . is further referred.

Since a cell resistance of the all solid-state battery cell 11 is lowered as the temperature is high, an optimal value of internal resistance of the all solid-state battery cell 11 is equal to “SOC×temperature×cell load”. For this reason, for example, a pressure sensor which comes in contact with the all solid-state battery module 12 and detects the load applied to the all solid-state battery cell 11 is further formed, an optimal load of all solid-state battery cell 11 is calculated by monitoring the SOC, the temperature, and the cell load. Then, the internal resistance of individual all solid-state battery cell 11, 11 . . . can become in an optimal state by controlling the alternating temperature device 13 on the basis of the optimal load of such all solid-state battery cell 11.

The above described embodiments of the invention are presented as examples and are not intended to limit the scope of the invention. These embodiments can be implemented in various other forms, and various omissions, substitutions, and modifications can be made without departing from the gist of the invention. These embodiments and variations thereof are included within the scope of the claims and their equivalents as well as within the scope and gist of the invention.

### INDUSTRIAL APPLICABILITY

The all solid-state battery unit of the present invention can realize an all solid-state battery unit, which is always stabilized even if the State of Charge are changed (decreased), by controlling the internal resistance of the all solid-state battery cell so as to maximize a charge property at a charge time and a discharge property at a discharge time depending on the states such as State of Charge (SOC) and temperature of the all solid-state battery module. Such all solid-state battery unit can improve energy efficiency when using as a secondary battery of a vehicle such an EV and a HEY. Consequently, the present invention has an industrial applicability.

What is claimed is:

1. An all solid-state battery unit, comprising:
an all solid-state battery module in which a plurality of all solid-state battery cells are laminated;
an alternating temperature unit configured to heat or cool the all solid-state battery module; and
a control unit configured to control the alternating temperature unit,
wherein the control unit controls the alternating temperature unit depending on either or both of values of a State of Charge of the all solid-state battery module and a temperature of the all solid-state battery module.

2. The all solid-state battery unit according to claim 1,
wherein the control unit performs a control to increase the temperature of the all solid-state battery module by the alternating temperature unit in response to a decrease of the State of Charge of the all solid-state battery module.

3. The all solid-state battery unit according to claim 1,
wherein a surface pressure increasing member composed of a thermal expandable materials is formed to come in contact with the all solid-state battery cell in the all solid-state battery module.

4. The all solid-state battery unit according to claim 1,
wherein the control unit has a temperature sensor configured to detect the temperature of the all solid-state battery module.

5. The all solid-state battery unit according to claim 1,
wherein the control unit further controls the alternating temperature unit depending on a value of a load applied to the all solid-state battery cell.

6. The all solid-state battery unit according to claim 1,
wherein the alternating temperature unit is a heater.
